(19) United States
(12) Patent Application Publication
(10) Pub. No.: US 2022/0250585 A1
(43) Pub. Date: Aug. 11, 2022

(54) Glass Breaking Alert Device

(71) Applicant: Brenda Griffin, Wyandanch, NY (US)

(72) Inventor: Brenda Griffin, Wyandanch, NY (US)

(21) Appl. No.: 17/389,895

(22) Filed: Jul. 30, 2021

Related U.S. Application Data
(60) Provisional application No. 63/148,169, filed on Feb. 11, 2021.

(51) Int. Cl. B60R 25/34; B60R 25/102; B60R 25/104; B60R 25/10; B60R 25/30

(52) U.S. Cl. CPC B60R 25/34; B60R 25/102; B60R 2325/205; B60R 25/1004; B60R 25/305; B60R 25/104

(57) ABSTRACT

The present invention relates to a glass break detecting device. The device is detachably attached to a windshield or a windowpane. The device sounds a loud alarm and additionally illuminates an LED within nanoseconds upon detecting that the glass to which the device is attached is broken or shattered. The device includes a piezoelectric sensor to detect vibrations in the glass to determine if the glass is broken. The device includes a built-in battery to power different components. The device can be manually turned by a user and provides real-time visual and audible alerts to notify individuals of the breakage and shattering of glass.

### CROSS-REFERENCE TO RELATED APPLICATION

The present application claims priority to, and the benefit of, U.S. Provisional Application No. 63/148,169, which was filed on Feb. 11, 2021 and is incorporated herein by reference in its entirety.

### FIELD OF THE INVENTION

The present invention relates generally to glass break detectors. More specifically, the present invention relates to a glass break detecting and alerting device configured to alert individuals when a glass is broken or shattered. The device can be removably attached to any type of glass such as a windshield or a windowpane. The device sounds a loud alarm and additionally illuminates a light-emitting diode (LED) within nanoseconds of detecting that the glass to which the device is attached is broken or shattered. The device includes a plurality of sensors to detect vibrations in the glass to determine if the glass is broken. Further, the device can be used with any type of glass such as a laminated or protected glass. Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

By way of background, windshields and windows of vehicles are susceptible to vandalism. Individuals can attempt to burglarize or vandalize a vehicle or its windshield. Side windows are generally broken by burglars or perpetrators to steal the contents of a vehicle. Or the vehicle itself. In such cases, the owner may be unaware that a person is attempting to burglarize or vandalize a vehicle. The perpetrator can damage the vehicle, burglarize the same and then escape. In most situations, the perpetrator cannot be identified or traced. Similarly, windowpanes of a building can be broken for unauthorized entry. When an unauthorized entrant breaks a glass window to gain access to a building, the occupants of the building may not know instantly or contemporaneously.

Presently, in automobiles, sensors to detect collision, movement around the vehicle or theft are present, but there is no sensor that can detect the shattering and breaking of a windshield and side windows. The windows are easy to vandalize and become easy targets for performing theft of the contents of the vehicle or the vehicle itself. Further, current sensors that are available cannot differentiate between the shattering of the glass and other light impact on the glass. Therefore, false positives can occur, which causes inconvenience to the users. Thus, there is a need for a window-breaking alert device that can alert individuals instantly of the breaking of a windowpane or a windshield.

Therefore, there exists a long felt need in the art for a glass-breaking alert device that can be used with any type of glass, such as that used in vehicle windshields and home windowpanes. There is also a long felt need in the art for a glass-breaking alert device that can instantly notify users about the shattering and breaking of glass. Additionally, there is a long felt need in the art for a glass-breaking alert device that is lightweight, small sized and that can differentiate between shattering and other light impacts on a glass. There is a long felt need in the art for a glass-breaking alert device that generates visual and audio alerts to notify users about the breaking of glass. Moreover, there is a long felt need in the art for a glass-breaking alert device that does not require any external power source for operation. Finally, there is a long felt need in the art for a glass-breaking alert device that provides a safe, convenient and reliable method to accurately notify users and central authorities of a glass breaking or shattering.

The subject matter disclosed and claimed herein, in one potential embodiment thereof, comprises a glass-breaking alert device. The alert device is configured to attach to a vehicle windshield, a vehicle side window or a home windowpane. The alert device further comprises one or more sensors to collectively detect vibrations of a glass to which the device is attached, a control button, an alarm, an LED, a camera, and a wireless transceiver. The device detects if the glass is broken or not, based on detected vibrations by one or more sensors. When the device detects that the glass is broken, the alarm generates a high frequency audio signal, the LED illuminates in a bright color and the camera is turned on and starts recording surrounding video. The control button is operated to turn on/off the device and the wireless transceiver establishes a wireless communication channel with a handheld electronic device to send notifications and to allow the electronic device to be used as a remote control to operate the alert device.

In this manner, the novel glass-breaking alert device of the present invention accomplishes all of the forgoing objectives, and provides a relatively safe, easy, and convenient solution to notify users about the shattering and breaking of vehicle windshields, windows and other glass surfaces. The glass breaking alert device of the present invention is convenient to use as it includes a built-in battery system and does not requires any external power source for operating the alert device. Additionally, the alert device can generate a shrill and loud alarm, when broken glass is detected to alert any nearby users; and can send a wireless notification to a paired electronic device of the user to alert the user who may not be nearby.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a glass-breaking alert device. The alert device is configured to attach to a vehicle windshield, a vehicle side window or a home windowpane. The alert device further comprises one or more sensors to collectively detect vibrations of a glass to which the device is attached, a control button, an audio alert, a visual alert (i.e. LED), a camera and a wireless transceiver. The device detects if the glass is broken or not, based on detected vibrations by one or more sensors and when the device detects that the glass is broken, the alarm generates a high frequency audio signal, the LED illuminates in a bright color, and the camera is turned on and starts recording surrounding video. The control button is operated to turn on/off the device and the wireless transceiver establishes a wireless communication channel with a handheld electronic device to send notifications and to allow the electronic device to be used as a remote control to operate the alert device.

In a further embodiment of the present invention, the one or more sensors of the device includes a piezoelectric sensor, an acoustic sensor, or a pressure sensor. The sensors provide an electrical signal to the audio alarm, the LED, and the camera when glass breaking or shattering is detected based on the detected vibrations of the glass.

In yet a further embodiment of the present invention, a window break detector configured to generate real-time alert when the window is broken or shattered is disclosed. The window break detector includes an alarm that sounds a loud and audible alarm when the window is broken wherein a piezoelectric vibration sensor detects vibration of the window glass to detect that the window is broken or shattered and converts the vibration signal into an electrical signal to instruct the alarm to sound the loud and audible alarm. The vibration sensor further sends an instruction to a visual alert (i.e. LED) for illumination and also to an integrated camera for activation in order to capture a visual of the surroundings.

In a further embodiment of the present invention, a glass-break detector configured to generate audible and visual alerts when a glass, to which the glass-break detector is attached, breaks or shatters is disclosed. The glass-break detector includes a vibration sensor to sense vibrations in the glass to detect a glass break event based on the frequency and intensity of the vibrations. The break detector further includes an alarm to generate an audio alert and an LED to illuminate when the glass break event is detected by the vibration sensor. The glass-break detector includes a built-in battery to provide power to the LED and the alarm for providing the alerts.

In a further embodiment of the present invention, the built-in battery may be recharged using a solar panel present on a front surface of the glass break detector. The solar panel converts solar energy into electrical energy to recharge the internal battery.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a front perspective view of one potential embodiment of a glass window-breaking alert device of the present invention in accordance with the disclosed architecture;

FIG. 1B illustrates a rear perspective view of one potential embodiment of the glass window-breaking alert device of the present invention in accordance with the disclosed architecture;

FIG. 2 illustrates a block diagram showing exemplary components of one potential embodiment of the glass window-breaking alert device of the present invention in accordance with the disclosed architecture;

FIG. 3 illustrates a flow diagram showing steps in activating audible and visual alerts by one potential embodiment of the glass-breaking alert device of the present invention in accordance with the disclosed architecture;

FIG. 4 illustrates a perspective view showing a wireless connection between one potential embodiment of the glass-breaking alert device of the present invention and a smartphone in accordance with the disclosed architecture;

FIG. 5 illustrates a perspective view of one potential embodiment of the glass-breaking alert device of the present invention attached to a front windshield of a vehicle in accordance with the disclosed architecture; and

FIG. 6 illustrates a perspective view of one potential embodiment of the glass-breaking alert device of the present invention attached to a windowpane in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a glass-breaking alert device that can be used with any type of glass such as used in vehicle windshields and home windowpanes. There is also a long felt need in the art for a glass-breaking alert device that can instantly notify users about shattering and breaking of the glass. Additionally, there is a long felt need in the art for a glass-breaking alert device that is lightweight, small sized and can differentiate between shattering and other light impacts on a glass. There is a long felt need in the art for a glass-breaking alert device that generates visual and audio alerts to notify users about breaking of glass. Moreover, there is a long felt need in the art for a glass-breaking alert device that does not require any external power source for operation. Finally, there is a long felt need in the art for a glass-breaking alert device that provides a safe, convenient and reliable method to accurately notify users and central authorities of a glass breaking or shattering.

The present invention, in one exemplary embodiment, is a novel windshield break detector. The detector is configured to generate a real-time alert when the windshield is broken or shattered. The windshield break detector can include a piezoelectric vibration sensor that detects vibrations of the windshield glass to determine that the windshield is broken or shattered, and converts the vibration signal into an electrical signal to instruct the alarm to sound a loud and audible alert/alarm. The vibration sensor can further send an instruction to an LED for illumination and also to an integrated camera to turn on in order to visually capture the surroundings.

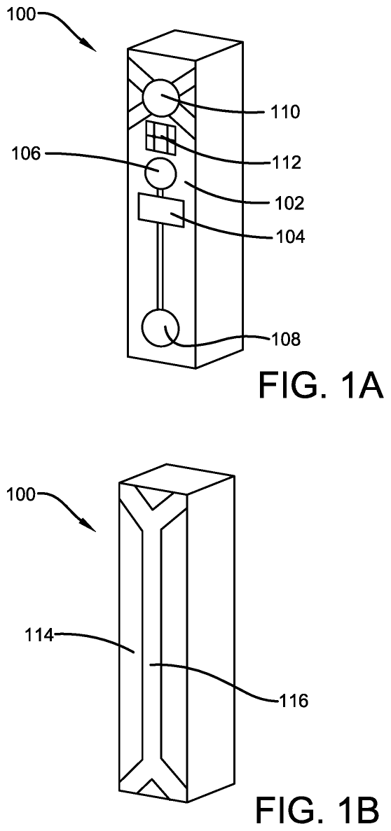

Referring initially to the drawings, FIG. 1A illustrates a front perspective view of one potential embodiment of a glass window-breaking alert device of the present invention in accordance with the disclosed architecture. The glass window-breaking alert device 100 is a generally cuboidal shaped device configured to attach to a glass window such as a windshield, rear window, side window of a vehicle, or any glass window of a building. The alert device 100 includes a vibration sensor that detects the vibration of the glass on which the device 100 is attached to detect breakage of glass and provides visual and audio notifications to indicate that glass is broken.

The alert device 100 includes a front surface 102 that faces away from the glass on which the device 100 is attached. The front surface 102 includes a toggle control button 104, a a visual alert (i.e. LED) 106, a camera 108, an audio alarm 110, and a solar panel 112. It should be noted that all the components of the device 100 are connected to each other through an internal wired circuit. The control button 104 enables a user to manually turn ON/OFF the device 100. The device 100 can include a touch button instead of the toggle control button in some embodiments. The alarm 110 can be configured to emit a shrill and loud sound when the broken glass is detected. The visual alert/LED 106 provides a visual notification about the broken glass. The camera 108 is turned on (i.e. activated) at the instant when the device 100 detects the shattering or breaking of the glass on which the device 100 is attached to capture the surroundings of the glass in order to record and capture a perpetrator. An internal battery 206 provides power to the components of the device 100 and is replaceable. A small solar panel 112 is present on the front surface 102 of the device 100 to absorb sunlight and convert the same into electrical energy to recharge the internal battery. The solar panel 112 is an optional feature and may be present in some embodiments of the present invention.

The glass-breaking alert device 100 sounds off within nanoseconds of the glass breaking. The device 100 is useful in detecting a windshield breaking, and to allow the owner and other nearby individuals to immediately know that the windshield is broken, thereby facilitating individuals to catch a perpetrator doing the vandalism or attempting burglary. The device 100 detects the vibrations of the glass to which it is attached. A predetermined threshold vibration value or level can be stored within the device 100 to reduce false positives such that the device 100 provides audible and visual alerts only in cases where the vibrations are strong, for example, when the glass is shattered or broken. The vibrations such as due to rain or hailstorm hitting a glass window or windshield of a vehicle do not cause the device 100 to activate the alerts and other components. The windshield or glass breaking alert device 100 can be of any geometrical shape and can have any design. The device 100 can attach to any glass surface having any shape and curvature.

FIG. 1B illustrates a rear perspective view of the glass window-breaking alert device of the present invention in accordance with the disclosed architecture. The rear surface 114 of the alert device 100 includes an adhesive 116 with which the device 100 can be adhered or mounted to a windshield or a windowpane. It should be noted that any other physical connection can be used to mount the device 100 to a glass surface.

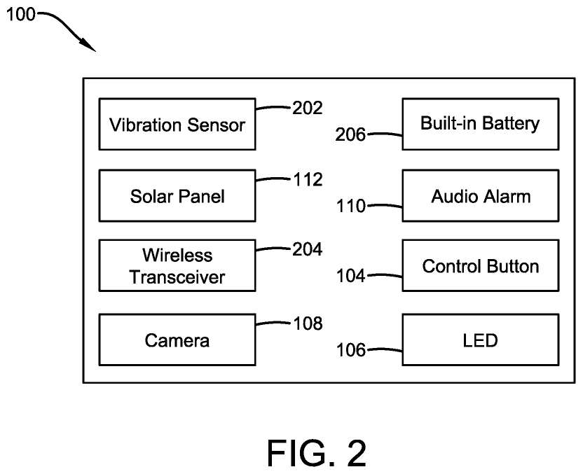

FIG. 2 illustrates a block diagram showing exemplary components of the glass window breaking alert device of the present invention in accordance with the disclosed architecture. The device 100 includes a built-in vibration sensor 202 that measures mechanical vibrations of the glass to which the device 100 is attached. The mechanical vibrations are used to determine if the glass is shattered or broken. The vibration sensor 202 can be a piezoelectric sensor such as a piezoelectric accelerometer. The piezoelectric accelerometer is an accelerometer that employs the piezoelectric effect of the glass to which it is attached to measure dynamic changes in mechanical variables such as vibrations and mechanical shock. Whenever the attached glass is shattered or broken, vibrations are caused in the molecules of the glass. The vibrations are detected by the vibration sensor 202 and are converted into electrical signals causing the audio alarm 110 to produce an audio alert. The vibration sensor 202 of the device 100 can be preconfigured with a threshold level based on the use of the device 100 to eliminate false positives. For example, an alert device 100 configured to be used with a laminated windshield glass may have a different threshold level compared to that of a threshold vibration value or level of the device to be used with a glass used in a window of a building.

A solar panel 112 converts solar energy into electrical energy to provide power to the built-in battery 206. The built-in battery 206 is replaceable and provides power to all the components of the device 100. A wireless transceiver 204 enables the device 100 to make a wireless communication with a handheld electronic device such as a smartphone, whereby the device 100 can send a notification to the electronic device when the vibration sensor 202 detects shattering or breaking of the glass.

A camera 108 can be configured to be turned on automatically when the device 100 detects the breaking of the glass. The recording of the camera 108 can be sent to the paired electronic device through the wireless communication channel. The LED alert 106 illuminates in a color such as “RED” to notify a person at a remote location about breaking of the glass to which the device 100 is attached. The LED alert 106 is especially useful at night and low light areas and can be visible from a long distance.

In one embodiment of the present invention, an acoustic sensor in addition to the vibration sensor 202 can also be present to detect breaking of the glass. The acoustic sensor can detect the high frequency sound signals or disturbance created during the shattering and breaking of the glass. It should be appreciated that the vibration sensor 202 alone or along with the acoustic sensor, or any other detector sensor, sufficiently distinguishes between low frequency vibrations/disturbances and high frequency vibrations/disturbances. The vibration sensor 202 can easily distinguish between rain or a ball bounce on the windowpane or windshield and a shattered windowpane or windshield.

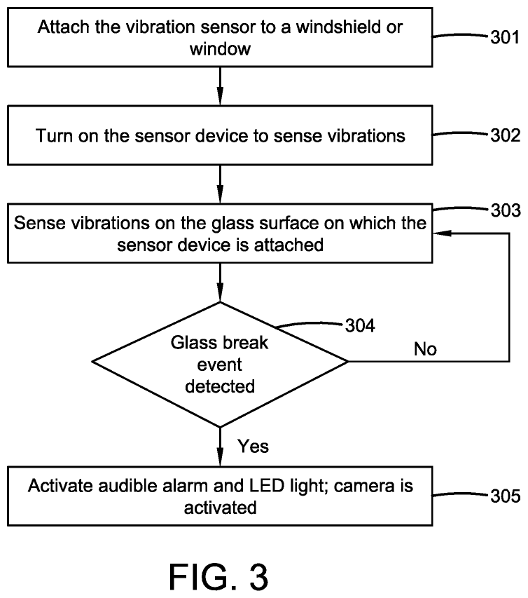

FIG. 3 illustrates a flow diagram showing the steps for activating audible and visual alerts by the glass-breaking alert device of the present invention in accordance with the disclosed architecture. As illustrated, initially the glass-breaking alert device of the present invention is attached to a windshield or a windowpane at a desired position (Block 301). Then, the device is turned ON using the control/touch button or remotely through a handheld electronic device (Block 302). As soon as the device is turned ON, the device using the vibration sensor and other sensors starts sensing the vibrations of the glass to which the device is attached (Block 303). It should be noted that continuous sensing of the vibrations and alternatively, automatically turning on of the device based on slight vibrations are embraced in the scope of the invention. When the vibrations are detected, the vibration sensor of the device detects the frequency of the vibrations and compares them to a pre-configured or predetermined threshold value to detect a glass breaking or shattering event (Block 304).

In cases where the glass breaking or shattering event is detected (Block 304), the device generates visual and audio notifications. Additionally, the camera of the device is also turned ON and a notification can be sent to a paired electronic device (Block 305). In cases where the glass breaking or shattering event is not detected, the device continues to sense the vibrations without generating any alerts.

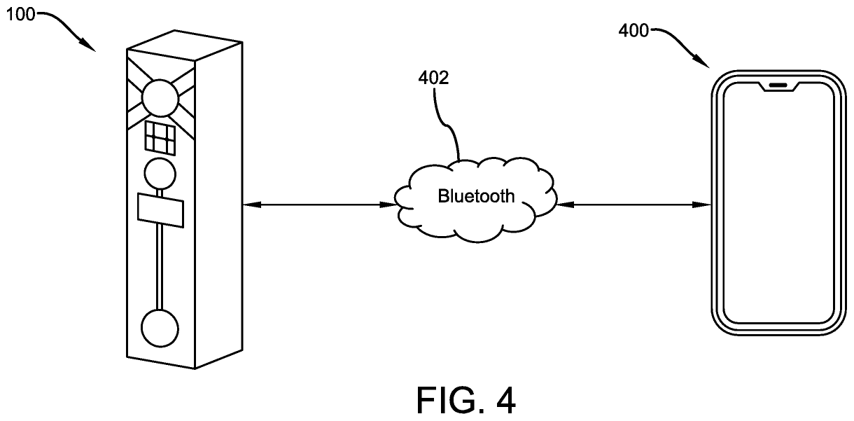

FIG. 4 illustrates a perspective view showing a wireless connection between one potential embodiment of the windshield-breaking alert device of the present invention attached and a paired smartphone in accordance with the disclosed architecture. As stated earlier, a wireless transceiver of the alert device 100 can be used to establish a wireless communication channel 402 between the device 100 and a paired handheld electronic device 400. The wireless communication channel 402 can be Bluetooth, near field communication (NFC), Infrared, RFID or any other conventional wireless technology known in the state of the art. The wireless communication channel 402 can be used to control the operation of the alert device 100 by the paired electronic device 400. Also, the alert device 100 can transmit real-time notifications and camera recordings to the electronic device 100, thereby enabling the owner or any other user to be aware instantly of the broken windshield or windowpane. This also ensures that the owner can immediately alert law enforcement in real-time of the detected activity.

The alert device 100 of the present invention is durable and sturdy. The components of the alert device 100 are waterproof and can sustain elements of weather. The exterior surface of the alert device 100 can be preferably constructed using ABS plastic or any other lightweight material.

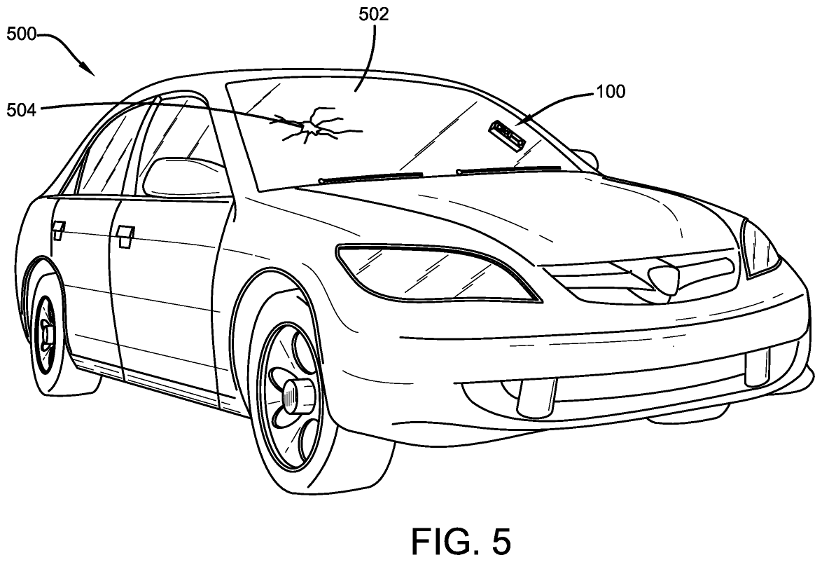

FIG. 5 illustrates a perspective view of one potential embodiment of the windshield-breaking alert device of the present invention attached to a front windshield of a vehicle in accordance with the disclosed architecture. As illustrated in FIG. 5, the vehicle 500 includes a front windshield 502 that is, for example, formed of laminated or safety glass. Further, the windshield break detector 100, including a vibration sensor, is attached to the windshield 502. For example, the windshield break detector 100 is rigidly mounted to an exterior surface of the windshield 502. In other examples, the alert device 100 can be rigidly mounted to an interior surface of the windshield 502 and/or attached to any side windows or rear windshield of the vehicle 500 (not illustrated). Further, in still other examples, the alert device 100 can be coupled to the windshield 502 along an edge of the windshield 502 to prevent the device 100 from obstructing a view of a driver and/or other occupant of the vehicle 500 (not illustrated).

The windshield-breaking alert device 100 of the present embodiment is configured to measure vibrations of the windshield 502 that can be caused by one or more reasons such as high-pressure sound waves impinging upon the windshield 502 or mechanical pressure on the windshield 502. The device 100 sounds off instantly when the windshield 502 is shattered or broken, or when a portion of the windshield is shattered 504. When the detected vibrations are greater than a threshold frequency, the device 100 initiates alerts to notify that the windshield is shattered or broken.

As stated earlier, the camera and LED of the device 100 can be automatically turned ON as soon as the alarm alerts from the detection of vibrations. The device 100 of the present invention is particularly useful for vehicles that are susceptible to vandalism. The device 100 can be pre-installed on the windshield of the vehicle 500 with a control on the dashboard to operate the device 100.

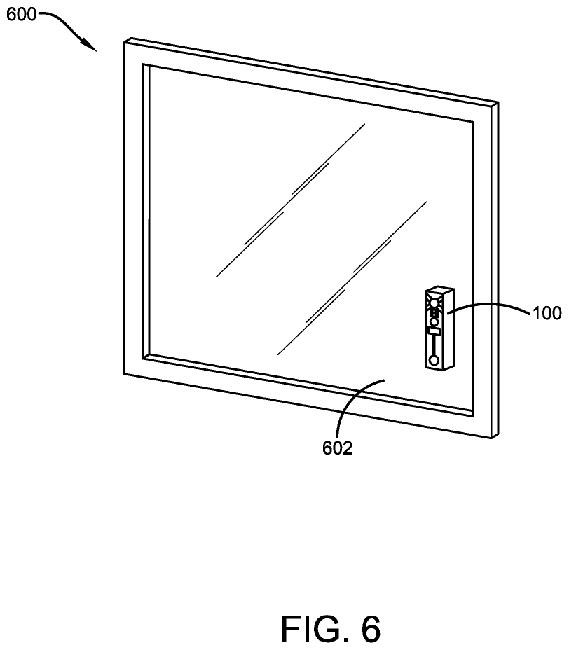

FIG. 6 illustrates a perspective view of one potential embodiment of the glass-breaking alert device of the present invention attached to a windowpane in accordance with the disclosed architecture. As illustrated, the alert device 100 is attached to a surface of the windowpane 600. The windowpane 600 can be of laminated, protected, or plane glass. The alert device 100 can be rigidly mounted to an interior surface 602 of the windowpane 600. In other examples, the alert device 100 can be rigidly mounted to an exterior surface of the windowpane 600. The device 100 provides alerts when the windowpane is shattered or broken, similar to the other embodiments of the present invention.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “glass window breaking alert device”, “glass breaking alert device”, “windshield breaking alert device”, “alert device”, “windshield break detector” and “device” are interchangeable and refer to the glass window breaking alert device 100 of the present invention.

Notwithstanding the forgoing, the glass window breaking alert device 100 of the present invention can be of any suitable size and configuration as is known in the art without affecting the overall concept of the invention, provided that it accomplishes the above-stated objectives. One of ordinary skill in the art will appreciate that the size, configuration, and material of the glass window breaking alert device 100 as shown in the FIGS. are for illustrative purposes only, and that many other sizes and shapes of the glass window breaking alert device 100 are well within the scope of the present disclosure. Although the dimensions of the glass window breaking alert device 100 are important design parameters for user convenience, the glass window breaking alert device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A glass breaking alert device for detecting breaks in a glass surface, the glass breaking alert device comprising:
a glass breaking detector mounted to the glass surface;
said glass breaking detector including at least one sensor to detect a vibration;
said glass breaking sensor further includes a predeterminable threshold level;
an audible alert activation when said vibration is greater than said predeterminable threshold level;
a visual alert activation when said vibration is greater than said predeterminable threshold level;
a camera activation when said vibration is greater than said predeterminable threshold level;
a wireless transceiver to send an instant wireless notification to a paired electronic device when said vibration is greater than said predeterminable threshold level; and
a battery for powering the glass breaking alert device.

2. The glass breaking alert device of claim 1, wherein said sensor distinguishes between a low frequency disturbance and a high frequency disturbance.

3. The glass breaking alert device of claim 1, wherein said paired electronic device is a smartphone and said instant wireless notification is in real-time.

4. The glass breaking alert device of claim 1, wherein said at least one sensor is a vibration detecting sensor and said vibration detecting sensor distinguishes between a low frequency vibration and a high frequency vibration.

5. The glass breaking alert device of claim 1, wherein said at least one sensor is a piezoelectric sensor.

6. The glass breaking alert device of claim 1, wherein said at least one sensor is an acoustic sensor and said acoustic sensor distinguishes between a low frequency sound signal and a high frequency sound signal.

7. The glass breaking alert device of claim 1, wherein said at least one sensor is a pressure sensor.

8. The glass breaking alert device of claim 3, wherein said wireless transceiver sends another instant wireless notification to another paired electronic device when said vibration is greater than said predeterminable threshold level, and further wherein said another paired electronic device is a central authority.

9. The glass breaking alert device of claim 3 further comprising a solar panel for recharging said battery.

10. A device for detecting a break in a glass surface, the device comprising:
a glass breaking detector mounted to the glass surface;
said glass breaking detector comprising at least one sensor to detect a vibration in said glass surface;
said at least sensor further includes a predeterminable threshold level;
an audible alert activation when said vibration is greater than said predeterminable threshold level;
a wireless transceiver to send an instant wireless notification to a paired electronic device when said vibration is greater than said predeterminable threshold level; and
a battery for powering the device, wherein said at least sensor distinguishes between a low frequency disturbance and a high frequency disturbance, and further wherein said paired electronic device is a smartphone and said instant wireless notification is in real-time.

11. The device of claim 10 further comprising a visual alert activation when said vibration is greater than said predeterminable threshold level.

12. The device of claim 10 further comprising a camera activation when said vibration is greater than said predeterminable threshold level.

13. The device of claim 10, wherein said at least one sensor is a vibration detecting sensor and said vibration detecting sensor distinguishes between a low frequency vibration and a high frequency vibration.

14. The device of claim 10, wherein said at least one sensor is a piezoelectric sensor.

15. The device of claim 10, wherein said at least one sensor is an acoustic sensor and said acoustic sensor distinguishes between a low frequency sound signal and a high frequency sound signal.

16. The device of claim 10, wherein said wireless transceiver sends another instant wireless notification to another paired electronic device when said vibration is greater than said predeterminable threshold level, and further wherein said another paired electronic device is a central authority.

17. A method of detecting a break in a glass surface and alerting a user of the break, the method comprising the steps of:
mounting a glass breaking detector to the glass surface;
detecting a vibration in said glass surface by said glass breaking detector;
setting a predeterminable threshold level in said glass breaking detector;
activating an audible alert when said vibration is greater than said predeterminable threshold level;
activating a visual alert when said vibration is greater than said predeterminable threshold level;
sending an instant wireless notification from a wireless transceiver to a paired electronic device when said vibration is greater than said predeterminable threshold level; and
powering said detector with a battery, wherein said paired electronic device is a smartphone and said instant wireless notification is in real-time.

18. The method of claim 17, further comprising activating a camera when said vibration is greater than said predeterminable threshold level.

19. The method of claim 17, wherein said glass surface is a vehicle glass surface.

20. The method of claim 17, wherein said glass surface is a home windowpane.
